(19) United States
(12) Patent Application Publication
(10) Pub. No.: US 2026/0067011 A1
(43) Pub. Date: Mar. 5, 2026

(54) INTERFERENCE WEIGHTING BASED SUBBAND SELECTION PROCEDURE

(71) Applicant: Nokia Technologies Oy, Espoo (FI)

(72) Inventors: Dong LI, Shanghai (CN); Tao TAO, Shanghai (CN); Paolo BARACCA, Stuttgart (DE); Saeed Reza KHOSRAVIRAD, Mountainside, NJ (US)

(21) Appl. No.: 19/106,661

(22) PCT Filed: Aug. 29, 2022
(86) PCT No.: PCT/CN2022/115541

§ 371 Date: Feb. 26, 2025

(51) Int. Cl. H04B 17/309; H04L 5/00; H04W 28/24

(52) U.S. Cl. CPC H04B 17/346; H04L 5/0051; H04W 28/24

(57) ABSTRACT

Embodiments of the present disclosure relate to devices, methods, apparatuses and computer readable storage media of interference weighting based sub-band selection procedure. The method comprises receiving, from a second device in a radio access network, a configuration for determining a weighted inter-subnetwork interference between a first subnetwork of the radio access network and at least one second subnetwork of the radio access network, wherein the configuration is indicative of at least one of a first weighting or a second weighting for the weighted inter-subnetwork interference; determining the weighted inter-subnetwork interference at least based on the configuration; and transmitting the weighted inter-subnetwork interference to the second device for selecting at least one sub-band for the first subnetwork. In this way, weighting operations may be proposed for the inter-subnetwork interferences and the associated low-complexity sub-band selection procedure to minimize the sum weighted interference over all the subnetworks, which may flexibly optimize and balance various system performance.

### FIELD

Embodiments of the present disclosure generally relate to the field of telecommunication and in particular to devices, methods, apparatuses and computer readable storage media of interference weighting based sub-band selection procedure.

### BACKGROUND

The In-X subnetwork (hereinafter may also be referred to as subnetwork) has been proposed as a promising component to satisfy the extreme performance requirements in terms of latency, reliability and/or throughput envisioned for some short-range scenarios in 6th Generation (6G) radio access technology. For example, the subnetworks may be installed in specific entities e.g., in-vehicle, in-body, in-house, etc., to provide life-critical data service with extreme performances over the local capillary coverage.

### SUMMARY

In general, example embodiments of the present disclosure provide a solution of interference weighting based sub-band selection procedure.

In a first aspect, there is provided a first device in a first subnetwork of a radio access network. The first device comprises at least one processor; and at least one memory storing instructions that, when executed by the at least one processor, cause the first device at least to receive, from a second device in the radio access network, a configuration for determining a weighted inter-subnetwork interference between the first subnetwork and at least one second subnetwork of the radio access network, wherein the configuration is indicative of at least one of a first weighting or a second weighting for the weighted inter-subnetwork interference; determine the weighted inter-subnetwork interference at least based on the configuration; and transmit the weighted inter-subnetwork interference to the second device for selecting at least one sub-band for the first subnetwork.

In a second aspect, there is provided a second device in a radio access network. The second device comprises at least one processor; and at least one memory storing instructions that, when executed by the at least one processor, cause the second device at least to transmit, to at least one first device in at least one subnetwork of the radio access network, a configuration for determining a weighted inter-subnetwork interference among the at least one subnetwork, wherein the configuration is indicative of at least one of a first weighting or a second weighting for the weighted inter-subnetwork interference; and receive from the at least one first device, the weighted inter-subnetwork interference for selecting at least one sub-band for the at least one subnetwork.

In a third aspect, there is provided a third device in a first subnetwork of a radio access network. The third device comprises at least one processor; and at least one memory storing instructions that, when executed by the at least one processor, cause the third device at least to receive, from a first device in the first subnetwork, a configuration for determining a first interference vector, wherein the first interference vector is associated with a weighted inter-subnetwork interference between the first subnetwork and at least one second subnetwork of the radio access network, and the configuration is indicative of at least a first weighting for the weighted inter-subnetwork interference; and transmit, to the first device, a first interference vector determined based on the configuration.

In a fourth aspect, there is provide a method. The method comprises receiving, at a first device in a first subnetwork of a radio access network and from a second device in the radio access network, a configuration for determining a weighted inter-subnetwork interference between the first subnetwork and at least one second subnetwork of the radio access network, wherein the configuration is indicative of at least one of a first weighting or a second weighting for the weighted inter-subnetwork interference; determining the weighted inter-subnetwork interference at least based on the configuration; and transmitting the weighted inter-subnetwork interference to the second device for selecting at least one sub-band for the first subnetwork.

In a fifth aspect, there is provide a method. The method comprises from a second device in a radio access network transmitting, to at least one first device in at least one subnetwork of the radio access network, a configuration for determining a weighted inter-subnetwork interference among the at least one subnetwork, wherein the configuration is indicative of at least one of a first weighting or a second weighting for the weighted inter-subnetwork interference; and receiving from the at least one first device, the weighted inter-subnetwork interference for selecting at least one sub-band for the at least one subnetwork.

In a sixth aspect, there is provide a method. The method comprises receiving, at a third device in a first subnetwork of a radio access network and from a first device in the first subnetwork, a configuration for determining a first interference vector, wherein the first interference vector is associated with a weighted inter-subnetwork interference between the first subnetwork and at least one second subnetwork of the radio access network, and the configuration is indicative of at least a first weighting for the weighted inter-subnetwork interference; and transmitting, to the first device, a first interference vector determined based on the configuration.

In a seventh aspect, there is provided an apparatus comprising means for receiving, from a second device in a radio access network, a configuration for determining a weighted inter-subnetwork interference between the first subnetwork of the radio access network and at least one second subnetwork of the radio access network, wherein the configuration is indicative of at least one of a first weighting or a second weighting for the weighted inter-subnetwork interference; means for determining the weighted inter-subnetwork interference at least based on the configuration; and means for transmitting the weighted inter-subnetwork interference to the second device for selecting at least one sub-band for the first subnetwork.

In an eighth aspect, there is provided an apparatus comprising means for transmitting, to at least one first device in at least one subnetwork of a radio access network, a configuration for determining a weighted inter-subnetwork interference among the at least one subnetwork, wherein the configuration is indicative of at least one of a first weighting or a second weighting for the weighted inter-subnetwork interference; and means for receiving from the at least one first device, the weighted inter-subnetwork interference for selecting at least one sub-band for the at least one subnetwork.

In a ninth aspect, there is provided an apparatus comprising means for receiving, from a first device in a first subnetwork of a radio access network, a configuration for determining a first interference vector, wherein the first interference vector is associated with a weighted inter-subnetwork interference between the first subnetwork and at least one second subnetwork of the radio access network, and the configuration is indicative of at least a first weighting for the weighted inter-subnetwork interference; and means for transmitting, to the first device, a first interference vector determined based on the configuration.

In a tenth aspect, there is provided a computer readable medium having a computer program stored thereon which, when executed by at least one processor of a device, causes the device to carry out the method according to the fifth aspect, the sixth aspect or the seventh aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of interference weighting based sub-band selection procedure according to some example embodiments of the present disclosure;

FIG. 3 shows a flowchart of an example method of interference weighting based sub-band selection procedure according to some example embodiments of the present disclosure;

FIG. 4 shows a flowchart of an example method of interference weighting based sub-band selection procedure according to some example embodiments of the present disclosure;

FIG. 5 shows a flowchart of an example method of interference weighting based sub-band selection procedure according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure.

It is noted that example embodiments of the present disclosure are equally applicable to other resources in other domains.

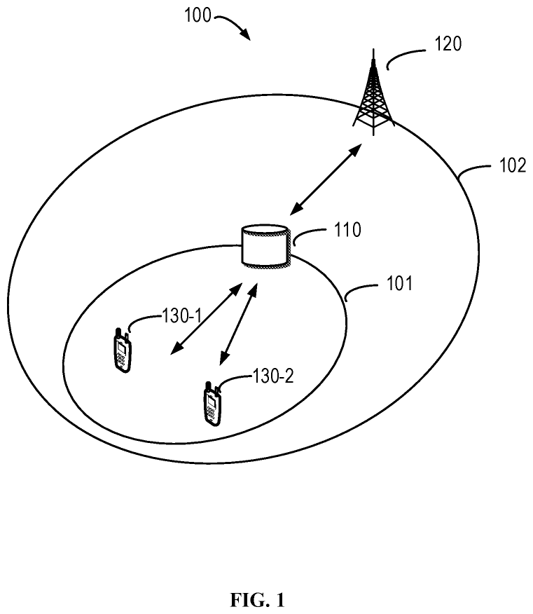

FIG. 1 shows an example communication network 100 in which embodiments of the present disclosure can be implemented. As shown in FIG. 1, the communication network 100 may comprise an access point (AP) 110 (hereinafter may also be referred to as a first device 110 or an in-X subnetwork AP 110). The AP 110 may be implemented as a terminal device or a network device. The communication network 100 may also comprise terminal devices 130-1 and 130-2 (hereinafter may also be referred to as an in-X subnetwork terminal device 130, an in-X subnetwork UE 130 or a third device 130 collectively). The AP 110 may communicate with the terminal devices 130-1 and 130-2 in a coverage 101, which may be referred to as an in-X subnetwork. The in-X subnetwork may be considered as a part of the communication network 100.

The communication network 100 may further comprise a network device 120 (hereinafter may also be referred to as a second device 120 or a base station (BS) 120), which may communicate with the AP 110 in a coverage 102. In some scenarios, the coverage 101 may be in the coverage 102. In some other scenarios, the coverage 101 may be out of the coverage 102.

It is to be understood that the number of in-X subnetworks, network devices and terminal devices shown in FIG. 1 is given for the purpose of illustration without suggesting any limitations. The communication network 100 may include any suitable number of network devices and terminal devices.

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, 6G radio access technology may expect extreme high requirements in terms of latency, reliability and/or throughput and the In-X subnetwork (i.e., subnetwork) may be considered as a promising component of 6G network to meet these extreme performance requirements.

In addition to support the extreme performance requirements, the subnetworks may be implemented with low transmit power which leads to the limited coverage. For a subnetwork, a star or tree topology may be implemented with one in-X subnetwork AP and one or more in-X subnetwork UEs under the AP's control. There is limited mobility for the subnetwork UEs across different subnetworks. A subnetwork may be part of overlay Wide Area Network (WAN) network but shall continue to work also when out of network coverage.

For example, typical in-X subnetwork use cases may comprise in-robot/in-production module subnetworks and in-vehicle subnetworks with extreme performance requirements in both reliability (up to 6 nines or more) and latency (down to the level of 100 us or even below) e.g., for the high demanding periodic deterministic communication services and these use cases may be the most challenging scenarios in 6G system.

On the one hand, the in-X subnetwork AP may serve and manage the in-X subnetwork UEs in the capillary subnetwork coverage, while on the other hand the in-X subnetwork AP may be connected to the BS of the overlay WAN, which could to a certain extent control and coordinate different subnetworks.

The specific architectural property of the subnetworks as mentioned above allows the possibility of centralized subnetwork resource selection by the overlay BS for the subnetworks to achieve extreme performances, as the overlay BS can have a whole picture of interference situations among the subnetworks and thus has large potential to achieve performance much better than the distributed subnetwork resource selections. In particular, the centralized subnetwork resource selection may play a significant role in extreme performance provisioning especially for the subnetworks that are in critical and challenging interference situations.

Furthermore, an enabling technical component for provisioning of extreme performance requirements especially in latency and reliability (e.g., 6 or more nines of reliability in latency of 100 us for motion control-like applications in in-production module subnetworks or in-vehicle subnetworks) is the sub-band channelization of the carrier, i.e., the carrier bandwidth is divided into multiple sub-bands and each subnetwork operates in one (or more) sub-band with continuous operations in time domain to provide extreme connections. In this case, the centralized subnetwork resource selection essentially comes down to the issue of centralized sub-band selection for the subnetworks so that each subnetwork is allocated one (or more) sub-band with inter-subnetwork interference kept as low as possible, especially for the subnetworks that have weak intra-subnetwork channels and/or have severe inter-subnetwork interferences.

Therefore, for the high demanding periodic deterministic communication services, it is to be expected that the interference may be minimized. To this aim, mainly two key points may need to be discussed, i.e., how to feedback the inter-subnetwork interferences from the subnetworks to the overlay BS to enable advanced centralized sub-band selection for subnetworks and to flexibly optimize and balance various system performance and how to design and implement an algorithm for centralized sub-band allocation to the subnetworks based on the inter-subnetwork interference feedback.

According to some example embodiments of the present disclosure, there is provided a solution for interference weighting based sub-band selection procedure. In this solution, the BS in a Radio Access Network (RAN) transmits, to an in-X subnetwork AP in a first subnetwork of the RAN, a configuration for determining a weighted inter-subnetwork interference between the first subnetwork and at least one second subnetwork of the RAN. The configuration may indicate at least one of a first weighting or a second weighting for the weighted inter-subnetwork interference. At least based on the received configuration, the in-X subnetwork AP determines the weighted inter-subnetwork interference and transmit the weighted inter-subnetwork interference to the BS for selecting at least one sub-band for the first subnetwork.

Example embodiments of the present disclosure will be described in detail below with reference to the accompanying drawings.

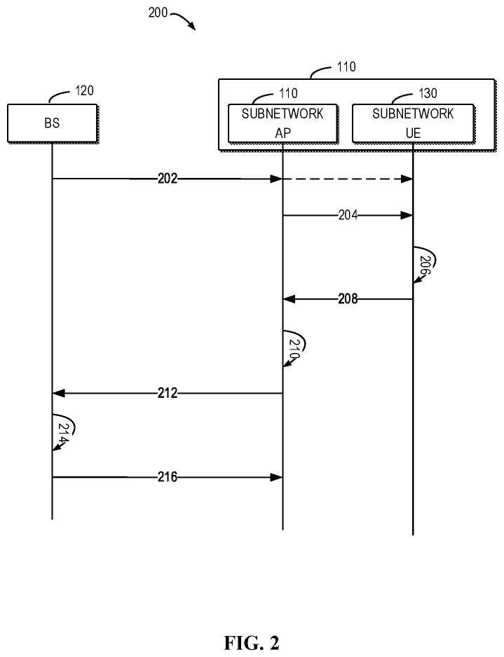

Reference is now made to FIG. 2, which shows a signaling chart 200 for communication according to some example embodiments of the present disclosure. As shown in FIG. 2, the signaling chart 200 involves an in-X subnetwork AP 110 (hereinafter may also be referred to AP 110), a BS 120 and an in-X subnetwork UE 130 (hereinafter may also be referred to UE 130). For the purpose of discussion, reference is made to FIG. 1 to describe the signaling chart 200. Although a single AP 110 and a single UE 130 are illustrated in FIG. 2, it would be appreciated that there may be a plurality of APs and a plurality of UEs performing similar operations as described with respect to the AP 110 and the UE 130 below, respectively.

As shown in FIG. 2, the BS 120 may transmit (at step 202), to the AP 110, a configuration for determining a weighted inter-subnetwork interference between the first subnetwork, at which the AP 110 is located, and at least one second subnetwork. For example, the configuration for determining the weighted inter-subnetwork interference may be transmitted from the BS 120 to AP 110 in the first subnetwork, or other AP(s) in the at least one second subnetwork via dedicated signalling and/or common signalling in groupcast or broadcast manner. In some embodiments, the configuration may consist of at least one of the following: 1) a first measurement configuration on reference signal of the first subnetwork; 2) a second measurement configuration on reference signal of the at least one second subnetwork; 3) first configuration information associated with the first weighting, or 4) second configuration information associated with the second weighting.

In some embodiments, the AP 110 may also forward (at step 204) the first and the second measurement configuration and the first configuration information mentioned above to the UE 130 in the first subnetwork for determining a first interference vector, wherein the first interference vector is associated with a weighted inter-subnetwork interference between the first subnetwork and the at least one second subnetwork of the radio access network. In some other embodiments, both the AP 110 and the UE 130 may receive the configuration for determining the weighted inter-subnetwork interference from the BS 120 directly. In this case, the UE 130 is assumed to have the capability to monitor the control and/or data transmissions from the BS 120.

In some example embodiments, the first measurement configuration may comprise configuration about the intra-subnetwork reference signal (RS) port(s) of the first subnetwork and the second measurement configuration may comprise at least the configuration for the RS port(s) of the at least one second subnetworks.

The configuration for the RS port(s) may comprise information about time/frequency/code resources for the RS port(s). Regarding the configuration of RS ports for different subnetworks, it is preferred that the RS (time/frequency) resources are arranged in the same transmission cycle or adjacent cycles and the RS ports are orthogonal or quasi-orthogonal to each other in time, frequency, or code domain to facilitate the measurements operations. Additionally, it may be assumed the subnetwork APs and/or the subnetwork UEs may be involved in the measurements for the intra-/inter-subnetwork RS signals.

Moreover, the first and the second configuration information contain the information associated with the first weighting and the second weighting respectively for the measured inter-subnetwork interference. In some embodiments, the interference weighting operations may be implemented in two stages, namely a first-stage weighting operation (i.e., the first weighting mentioned) with a channel-dependent weighting factor and a second-stage weighting operation (i.e., the second weighting mentioned) with a traffic QoS-dependent weighting factor. The 1^{st}-stage weighting operation may aim at adjusting the interference level as per vulnerability of the associated subnetwork link, while the 2^{nd}-stage weighting operation may be performed for the consolidated (or say combined) weighted interference vectors corresponding to multiple subnetwork UEs within the first subnetwork. The 2^{nd}-stage weighting operation may be performed for the consolidated weighted interference vector with a weighting factor determined by the subnetwork traffic QoS requirements.

For example, the first configuration information associated with the first weighting may be indicative of the first weighting based on channel-dependent weighting factor or channel-independent weighting factor. In case of the first weighting with channel-dependent weighting factor, the weighting factor may be the reciprocal of the intra-subnetwork channel gains between the AP 110 and the UEs in the first subnetwork, for example, the UE 130. In case of the first weighting with channel-independent weighting factor, the weighting factor may be fixed to one or other fixed value.

The second configuration information associated with the second weighting may be indicative of the mapping between traffic QoS requirements and a set of 2^{nd}-stage weighting factors. For example, the AP 110 may determine the 2^{nd}-stage weighting factor for the subnetwork based on the traffic QoS requirements of this subnetwork and the mapping rules indicated by the second configuration information associated with the second weighting. The rules on mapping between traffic QoS requirements and 2^{nd}-stage weighting factors may be pre-defined/pre-configured.

Based on the received configuration information on interference weighting and the measurement configurations on RS, the subnetwork nodes, e.g., the UE 130, may perform (at step 206) the corresponding inter-subnetwork interference measurements and the first weighting operation.

Assuming that the total frequency resources available for subnetwork operations are organized into M sub-bands, which are shared by all the N subnetworks (each subnetwork generally may occupy one sub-band to support the transmissions within the subnetwork) with N generally larger than M and the intra-subnetwork channel gains and the inter-subnetwork interference levels may be sub-band-selective depending on the sub-band bandwidth or channel coherence bandwidth. Assuming that there are Kₙ devices (with index set S_{K}_{ₙ}={1, 2, . . . , Kₙ}) involved in the interference management in the n-th subnetwork (or say subnetwork n), the measured/estimated useful and interfering received signal power by device k∈S_{K}_{ₙ} (e.g., the UE 130) over sub-band m∈S_{M}={1, 2, . . . , M} of the n-th subnetwork can be expressed as follows:

$$RX signal and interference vector = [ \text{} \begin{matrix}{w}_{n , 1}^{k , m} & … & {w}_{n , n - 1}^{k , m} & {w}_{n , n}^{k , m} & {w}_{n , n + 1}^{k , m} & … & {w}_{n , N}^{k , m}\end{matrix} ] \qquad ( 1 )$$

where the element

$${w}_{n , n}^{k , m}$$

denotes the intra-subnetwork useful signal and other elements are the inter-subnetwork interferences from each of the other subnetworks of S_{N} to the device k of the subnetwork n. It is to be understood that interferences denote the received power level including transmit power and channel gains.

Based on the measurement result, the UE 130 may perform the 1^{st}-stage weighting operation by using the 1^{st}-stage weighting factor.

In some embodiments, the 1^{st}-stage weighting factor may be a value of reciprocal of received useful signal power

$$( i . e . , {w}_{n , n}^{k , m} ) ,$$

thus the weighted interference vector (by the device-k of subnetwork-n and this interference vector may be called the first interference vector) may be determined as follows:

$${W}_{n}^{k , m} = \frac{1}{{w}_{n , n}^{k , m}} [ \begin{matrix}{w}_{n , 1}^{k , m} & … & {w}_{n , n - 1}^{k , m} & {w}_{n , n + 1}^{k , m} & … & {w}_{n , N}^{k , m}\end{matrix} ] , k ∈ {S}_{K} \qquad ( 2 )$$

It is to be understood that 1^{st}-stage weighting factor may also take other values in some other embodiments. The weighted interference vector may be obtained by a UE per each sub-band or per wideband.

In the process of the 1^{st}-stage weighting operation, the inter-subnetwork interference and intra-subnetwork useful link gains may be balanced, to achieve the purposes of interference minimization, throughput enhancement, and protection for the weak subnetworks.

The UE 130 then may feedback (at step 208) the result of the 1^{st}-stage weighting operation, i.e., weighted interference vector to the AP 110.

As another option, it is also possible that the UE 130 may provide the result of the interference measurement to the AP 110 and the 1^{st}-stage weighting operation may be performed at the AP 110 based on a similar way as described above.

Based on the weighted interference vectors, received from UEs in the subnetwork managed by the AP 110 or estimated by the AP 110 based on measurement results of these UEs, the AP 110 may consolidate the weighted interference vectors and perform (at step 210) the 2^{nd}-stage weighting operation.

For example, for the consolidation, as an option, the weighted interference vectors may be averaged or be added to obtain the consolidated weighted interference vector. For example, the AP 110 may calculate the average or the sum of the weighted interference vectors from the multiple UEs and take it as the consolidated weighted interference vector as follows:

$${\tilde{W}}_{n}^{m} = \frac{1}{\vert {S}_{{K}_{n}} \vert} {\sum }_{k ∈ {S}_{{K}_{n}}} {W}_{n}^{k , m} ; or \qquad ( 3 )$$

$${\tilde{W}}_{n}^{m} = {\sum }_{k ∈ {S}_{{K}_{n}}} {W}_{n}^{k , m} \qquad ( 4 )$$

where |S_{K}_{ₙ}| denotes the cardinality of the set S_{K}_{ₙ}. It is equal to Kₙ, i.e., the number of devices in the subnetwork n involved in the interference managements.

As another option, the AP may take the weighted interference vector from specific UE, e.g., a specific weighted interference vector with maximum aggregated weighted interference may be selected as the consolidated weighted interference vector. For example, a UE with the largest sum of the elements of W_{n,k}, may be described as follows:

$${\tilde{W}}_{n}^{m} = {W}_{n}^{k , m} \vert k = arg {max}_{k ∈ {S}_{{K}_{n}}} \{ {\sum }_{q = 1 , q \neq n}^{N} {w}_{n , q}^{k , m} / {w}_{n , n}^{k , m} \} \qquad ( 5 )$$

where in this case, it is to be understood that the AP 110 of the subnetwork n may only request the specific UE with index

$$k = arg {max}_{k ∈ {S}_{{K}_{n}}} \{ {\sum }_{q = 1 , q \neq n}^{N} {w}_{n , q}^{k , m} / {w}_{n , n}^{k , m} \}$$

to feedback the weighted interference vector. The consolidated weighted interference, denoted by

$${\tilde{W}}_{n}^{m} ,$$

may be called the second interference vector.

In the 2^{nd}-stage weighting operation, the consolidated weighted interference may be further weighted by the AP 110, for example, based on the 2^{nd}-stage weighting factor depending on traffic QoS requirement. The higher the traffic QoS requirements correspond to the larger the 2^{nd}-stage weighting factor. Thus, the interference measurements of the subnetworks with high demanding traffic type may be amplified to some extent to get more protection in the centralized sub-band selection.

For example, the 2^{nd}-stage weighting operation for the subnetwork n may be described as follows:

$${W}_{n}^{m} ← {f}_{n} \cdot {\tilde{W}}_{n}^{m} \qquad ( 6 )$$

where the weighting factor fₙ for the subnetwork n is determined as per the second configuration information associated with the second weighting or based on a pre-defined or pre-configured mapping rule between the traffic QoS requirements and the corresponding second weighting factors.

It is to be understood that for the weighted interference vector, both the sub-band-based interference vector feedback and the wideband-based interference vector feedback May be supported. For example, it may be (pre)configured that the sub-band-based interference vector feedback may be used if the sub-band bandwidth is relatively large and there is obvious channel frequency selectivity over different sub-bands. The subnetwork n may need to feedback

$${W}_{n}^{m} , m = 1 , 2 , … , M ,$$

to the overlay BS in case of sub-band-based interference vector feedback and the average interference vector over the multiple sub-bands, i.e.,

$${W}_{n} = \frac{1}{M} {\sum }_{m = 1}^{M} {W}_{n}^{m} ,$$

in case of wideband-based interference vector feedback. Here the interference vector(s) that the AP of the subnetwork n feedback to the overlay BS is called the weighted inter-subnetwork interference determined at least based on the configuration from the BS.

The AP 110 may transmit (at step 212) the result of the 2^{nd}-stage weighting operation, i.e., weighted inter-subnetwork interference, to the BS 120. It is to be understood that the BS 120 may receive the weighted inter-subnetwork interference from multiple APs in all the relevant subnetworks, for example, the first subnetwork associated with the AP 110 and at least one second subnetwork.

Based on the weighted inter-subnetwork interferences fed back from the relevant subnetwork APs, the BS 120 may construct the weighted interference matrix (IM). For example, the BS constructs the per-subnetwork interference matrix W as follows:

$$W = [ \begin{matrix}{W}_{1} \\ {W}_{2} \\ ⋮ \\ {W}_{N}\end{matrix} ] in case of wideband interference vector feedback ; or \qquad ( 7 )$$

$${W}_{: , : , m} = [ \begin{matrix}{W}_{1}^{m} \\ {W}_{2}^{m} \\ ⋮ \\ {W}_{N}^{m}\end{matrix} ] , m = 1 , 2 , … , M \qquad ( 8 )$$

$$in case of wideband interference vector feedback$$

In this way, the per-subnetwork interference matrix with size N-by-N (wideband feedback) or N-by-N-by-M (sub-band feedback) may be constructed (N is number of the subnetworks and M is number of sub-bands) by the BS 120. It is to be understood that the interference matrix over each of the third dimension is not necessarily symmetric, i.e., the entry corresponding to interference suffered by subnetwork n from subnetwork m is not necessarily the same of the interference suffered by subnetwork m from subnetwork n.

Based on the constructed interference matrix, a sub-band selection procedure is performed by the BS 120 (at step 214) to allocate the sub-bands to the subnetworks. For example, the sub-band selection procedure may be performed by the BS 120 in an iterative way to minimize the sum weighted interference over all the subnetworks.

The BS 120 may determine an order of the subnetworks for the resource selection procedure, e.g., as per the aggregated weighted interference suffered by the subnetwork receiver, the more interfered, the earlier they are processed.

Then the BS 120 may determine an initial sub-band allocation status (SAS) which shows the sub-band index assigned to each subnetwork. The initial SAS may be determined randomly, or fed back from subnetwork APs, or determined in other suitable manners.

The sub-band selection may be then performed iteratively for the subnetworks in the determined order. For the subnetwork that is under processing, for each of all the sub-bands, the sum weighted interference may be calculated based on the up-to-date SAS, which is sum of the two parts, namely the sum weighted interference from all other co-sub-band subnetworks and the sum weighted interference to all these co-sub-band subnetworks. Then the sub-band with least sum weighted interference may be selected as the interim sub-band selection for the subnetwork and then update the SAS accordingly.

It is to be understood that the procedure for sub-band selection as described above may be performed for multiple rounds, which may stabilize/minimize the sum weighted interference over all the subnetworks and get the final sub-band selection results.

For example, an algorithm for the iterative sub-band selection procedure may be represented as below:

TABLE 1
An example of sub-band selection iterative algorithm

| | | |
|---|---|---|
| Inputs: | - | Interference matrix W with size N-by-N-by-M (index set for subnetworks |
| | | involved in the sub-band selection S_{N} = {1, 2, ... , N}, sub-band index set |
| | | S_{M} = {1, 2, ... , M} , W(i, j, m) denotes received interference at |
| | | subnetwork-i from subnetwork-j over sub-band- m, weighted by a factor |
| | | which is channel dependent and/or traffic QoS requirements dependent for |
| | | the subnetwork-i). |
| | - | Initial sub-band allocation status (SAS): A₀ (n) ∈ S_{M}, ∀n ∈ S_{N} , |
| | | B₀(m) = {n\|A₀(n) = m}. Denote the initial sum interference by I₀ = |
| | | Σ_{p∈S}_{_{N}}Σ_{q∈B}_{₀}_{(A}_{₀}₍ₚ₎₎ W(p, q, A₀(p)). |
| | - | Total iteration round number L |
| Steps: | - | Determine order of the subnetworks for sub-band selection, denote by |
| | | C(n) ∈ S_{N} the n-th treated subnetwork |
| | - | for r=1 to L |
| | - | for n=1 to N \\ sub-band selection for subnetwork C(n) |
| | - | the current iteration number d = (r − 1) · N + n |
| | - | Compute D(k) = Σ_{q∈B}_{_{d−1}}₍ₖ₎(W(C(n), q, A_{d-1} (n)) + |
| | | W(q, C(n), A_{d-1} (n))), k ∈ S_{M} |
| | - | Update A_{d-1} to A_{d} : A_{d}(C(n)) = argminₖ {D(k)}; A_{d}(p) = |
| | | A_{d-1}(p) for p ∈ (S_{N}\C(n)) |
| | - | Update B_{d-1} to B_{d} : determine B_{d}(k), k ∈ S_{K} based on |
| | | A_{d}(p), p ∈ S_{N} |
| | - | Compute sum interference I_{d} = Σ_{p∈S}_{_{N}} Σ_{q∈B}_{_{d}}_{(A}_{_{d}}₍ₚ₎₎ W(p, q, A_{d}(p)) |
| | - | end for \\n |
| | - | end for \\r |
| | - | Stop the procedure and provide the output |
| Outputs: | - | Final sub-band allocation status A_{L·N} (n) ∈ S_{M}, ∀n ∈ S_{N} |
| | - | Final sum interference I_{L·N} |
| Notes: | | The above descriptions assume sub-band-specific interference matrix. It can |
| | | be adapted readily to the case of wideband interference matrix by removing |
| | | the 3^{rd} dimension of IM W. |

The algorithm may indicate an interesting and important property, i.e., the sum weighted interference over all the subnetworks decrease monotonically with the iterations. The proof for this property is provided as follows:

$${I}_{d = n + ( r - 1 ) \cdot N} = {\sum }_{p ∈ {S}_{N}} {\underbrace{{\sum }_{q ∈ {B}_{d} ( {A}_{d} ( p ) )} W ( p , q , {A}_{d} ( p ) )}}_{{F}_{d} ( p )} = {F}_{d} ( C ( n ) ) + {\sum }_{p ∈ ( {S}_{N} ∖ C ( n ) )} {F}_{d} ( p ) = {F}_{d} ( C ( n ) ) + {\sum }_{p ∈ ( {S}_{N} ∖ C ( n ) )} ( {F}_{d - 1} ( p ) + W ( p , C ( n ) , {A}_{d} ( p ) ) \cdot ( {1}_{{A}_{d} ( p )}^{{A}_{d} ( C ( n ) )} - {1}_{{A}_{d - 1 ( p )}}^{{A}_{d - 1} ( C ( n ) )} ) ) = {F}_{d} ( C ( n ) ) + {\sum }_{p ∈ ( {S}_{N} ∖ C ( n ) )} {F}_{d - 1} ( p ) + {\sum }_{p ∈ ( {S}_{N} ∖ C ( n ) )} W ( p , C ( n ) , {A}_{d} ( p ) ) {1}_{{A}_{d} ( p )}^{{A}_{d} ( C ( n ) )} - {\sum }_{p ∈ ( {S}_{N} ∖ C ( n ) )} W ( p , C ( n ) , {A}_{d} ( p ) ) {1}_{{A}_{d - 1} ( p )}^{{A}_{d - 1} ( C ( n ) )} = {I}_{d - 1} + ( {F}_{d} ( C ( n ) ) + {\sum }_{p ∈ ( {S}_{N} ∖ C ( n ) )} W ( p , C ( n ) , {A}_{d} ( p ) ) {1}_{{A}_{d} ( p )}^{{A}_{d} ( C ( n ) )} ) - ( {F}_{d - 1} ( C ( n ) ) + {\sum }_{p ∈ ( {S}_{N} ∖ C ( n ) )} W ( p , C ( n ) , {A}_{d} ( p ) ) {1}_{{A}_{d - 1} ( p )}^{{A}_{d - 1} ( C ( n ) )} ) \leq {I}_{d - 1} \qquad ( 9 )$$

where the term

$${1}_{x}^{y} = 1$$

if x=y and 0 otherwise. The conclusion of I_{d}≤I_{d-1} shows that the sum weighted interference over all the relevant subnetworks decreases with the iteration number.

Referring back to FIG. 2, after determining the sub-band selection, the BS 120 may inform (at step 216) the sub-band selection results to the respective subnetwork APs, for example, to the AP 110. The subnetworks e.g., the first subnetwork associated with the AP 110, may then apply the new allocated sub-bands at the same time as per instructions from the BS 120.

The solution of the present disclosure proposes weighting operations for the inter-subnetwork interferences and the associated low-complexity sub-band selection procedure to minimize the sum weighted interference over all the subnetworks, which may flexibly optimize and balance various system performance aspects e.g., interference avoidance/minimization, throughput enhancement, protection for the weak subnetworks (i.e., with weak channels and/or large interference), and preference for subnetworks with high demanding traffic type.

Furthermore, the consolidation of the intra-subnetwork multiple weighted interference vectors and the flexible configuration of sub-band or wideband-based feedback is helpful to balance the feedback overhead and the system performance.

In the way, the extreme reliability performance requirements may be achieved for the subnetworks.

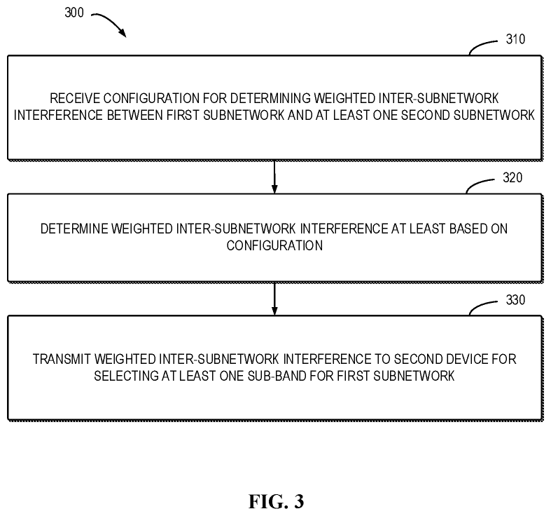

FIG. 3 shows a flowchart of an example method 300 of interference weighting based sub-band selection procedure according to some example embodiments of the present disclosure. The method 300 may be implemented at the first device 110 as shown in FIG. 1. For the purpose of discussion, the method 300 will be described with reference to FIG. 1.

At 310, the first device 110, in a first subnetwork of a radio access network, receive, from a second device in the radio access network, a configuration for determining a weighted inter-subnetwork interference between the first subnetwork and at least one second subnetwork of the radio access network. The configuration is indicative of at least one of a first weighting or a second weighting for the weighted inter-subnetwork interference.

In some example embodiments, the first device may receive the configuration for determining the weighted inter-subnetwork interference via at least one of a dedicated signaling, or a common signaling.

In some example embodiments, the configuration for determining the weighted inter-subnetwork interference comprises at least one of a first measurement configuration on reference signal of the first subnetwork, a second measurement configuration on reference signal of the at least one second subnetwork, first configuration information associated with the first weighting, or second configuration information associated with the second weighting.

In some example embodiments, the first device may transmit, to at least one third device in the first subnetwork, the first and the second measurement configuration and the first configuration information; and receive, from the at least one third device, at least one first interference vector determined based on the first and the second measurement configuration and the first configuration information.

At 320, the first device determines the weighted inter-subnetwork interference at least based on the configuration.

In some example embodiments, the configuration for determining the weighted inter-subnetwork interference comprises the second configuration information, the first device may obtain a second interference vector based on the at least one first interference vector received from the at least one third device; determine a second weighting factor corresponding to a service quality requirement of the first subnetwork based on the second configuration information associated with the second weighting; and determine the weighted inter-subnetwork interference based on the second interference vector and the second weighting factor.

In some example embodiments, the second configuration information associated with the second weighting is indicative of a mapping between a plurality of second weighting factors and different service quality requirements, the first device may determine the second weighting factor based on the service quality requirement of the first subnetwork and the mapping.

In some example embodiments, the first device may obtain the second interference vector by calculating an average of the at least one first interference vector, or by calculating the sum of the at least one first interference vector, or by selecting from the at least one first interference vector, a first interference vector having a maximum aggregated weighted interference.

At 330, the first device transmits the weighted inter-subnetwork interference to the second device for selecting at least one sub-band for the first subnetwork.

In some example embodiments, the first device may receive, from the second device, information indicative of the at least one sub-band for the first subnetwork after transmitting the weighted inter-subnetwork interference to the second device.

In some example embodiments, the first device comprises an access point, the second device comprises a base station and the third device comprises a terminal device.

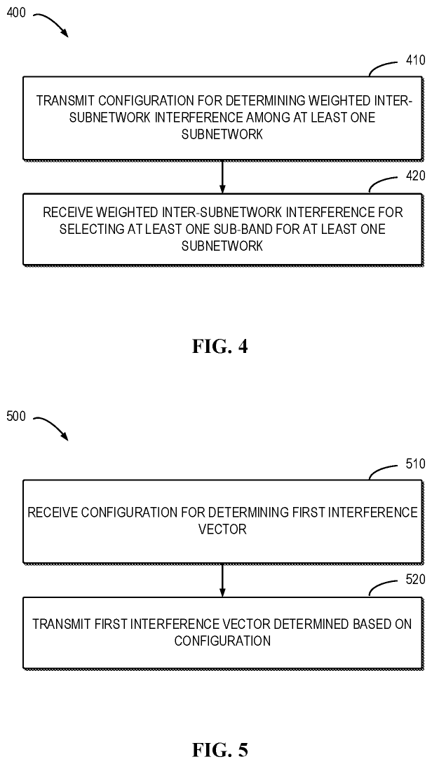

FIG. 4 shows a flowchart of an example method 400 of interference weighting based sub-band selection procedure according to some example embodiments of the present disclosure. The method 400 may be implemented at the second device 120 as shown in FIG. 1. For the purpose of discussion, the method 400 will be described with reference to FIG. 1.

At 410, the second device, in a radio access network, transmits, to at least one first device in at least one subnetwork of the radio access network, a configuration for determining a weighted inter-subnetwork interference among the at least one subnetwork. The configuration is indicative of at least one of a first weighting or a second weighting for the weighted inter-subnetwork interference.

In some example embodiments, the second device may transmit the configuration for determining the weighted inter-subnetwork interference to the at least one first device via at least one of a dedicated signaling, or a common signaling.

In some example embodiments, the configuration for determining the weighted inter-subnetwork interference comprises at least one of a measurement configuration on reference signal of the at least one subnetwork, first configuration information associated with the first weighting, or second configuration information associated with the second weighting.

In some example embodiments, the second configuration information associated with the second weighting is indicative of a mapping between a plurality of second weighting factors and different service quality requirements.

At 420, the second device receives, from the at least one first device, the weighted inter-subnetwork interference for selecting at least one sub-band for the at least one subnetwork.

In some example embodiments, the second device may select the at least one sub-band for the at least one subnetwork based at least on the weighted inter-subnetwork interference; and transmit to the at least one first device in the at least one subnetwork, the at least one sub-band.

In some example embodiments, the first device comprises an access point and the second device comprises a base station.

FIG. 5 shows a flowchart of an example method 500 of interference weighting based sub-band selection procedure according to some example embodiments of the present disclosure. The method 500 may be implemented at the UE 130 as shown in FIG. 1. For the purpose of discussion, the method 500 will be described with reference to FIG. 1.

At 510, the third device, in a first subnetwork of a radio access network, receives, from a first device in the first subnetwork, a configuration for determining a first interference vector. The first interference vector is associated with a weighted inter-subnetwork interference between the first subnetwork and at least one second subnetwork of the radio access network, and the configuration is indicative of at least a first weighting for the weighted inter-subnetwork interference.

In some example embodiments, the configuration for determining the weighted inter-subnetwork interference comprises at least one of a first measurement configuration on reference signal of the first subnetwork, a second measurement configuration on reference signal of the at least one second subnetwork, or first configuration information associated with the first weighting.

At 520, the third device transmits, to the first device, a first interference vector determined based on the configuration.

In some example embodiments, the third device may perform an interference measurement on the reference signal of the first network and the at least one second subnetwork based on the first and the second measurement configuration on the RS port(s).

In some example embodiments, the third device may determine the first interference vector based on measurement result of the interference measurement and a first weighting factor for the first weighting determined based on the first configuration information associated with the first weighting.

In some example embodiments, the first weighting factor is a reciprocal of measured received power of the reference signal of the first subnetwork.

In some example embodiments, the first device comprises an access point and the third device comprises a terminal device.

In some example embodiments, an apparatus capable of performing the method 300 (for example, implemented at the first device 110) may include means for performing the respective steps of the method 300. The means may be implemented in any suitable form. For example, the means may be implemented in a circuitry or software module.

In some example embodiments, the apparatus comprises means for means for receiving, from a second device in a radio access network, a configuration for determining a weighted inter-subnetwork interference between a first subnetwork of the radio access network and at least one second subnetwork of the radio access network, wherein the configuration is indicative of at least one of a first weighting or a second weighting for the weighted inter-subnetwork interference; means for determining the weighted inter-subnetwork interference at least based on the configuration; and means for transmitting the weighted inter-subnetwork interference to the second device for selecting at least one sub-band for the first subnetwork.

In some example embodiments, the means for receiving the configuration for determining the weighted inter-subnetwork interference comprises means for receiving the configuration via at least one of a dedicated signaling, or a common signaling.

In some example embodiments, the configuration for determining the weighted inter-subnetwork interference comprises at least one of a first measurement configuration on reference signal of the first subnetwork, a second measurement configuration on reference signal of the at least one second subnetwork, first configuration information associated with the first weighting, or second configuration information associated with the second weighting.

In some example embodiments, the apparatus further comprises means for transmitting, to at least one third device in the first subnetwork, the first and the second measurement configuration and the first configuration information; and means for receiving, from the at least one third device, at least one first interference vector determined based on the first and the second measurement configuration and the first configuration information.

In some example embodiments, the configuration for determining the weighted inter-subnetwork interference comprises the second configuration information, the means for determining the weighted inter-subnetwork interference comprises means for obtaining a second interference vector based on the at least one first interference vector received from the at least one third device; means for determining a second weighting factor corresponding to a service quality requirement of the first subnetwork based on the second configuration information associated with the second weighting; and means for determining the weighted inter-subnetwork interference based on the second interference vector and the second weighting factor.

In some example embodiments, the second configuration information associated with the second weighting is indicative of a mapping between a plurality of second weighting factors and different service quality requirements, the means for determining the second weighting factor further comprises means for determining the second weighting factor based on the service quality requirement of the first subnetwork and the mapping.

In some example embodiments, the means for obtaining the second interference vector further comprises means for obtaining the second interference vector by performing calculating an average of the at least one first interference vector, or by calculating a sum of the at least one first interference vector, or by selecting from the at least one first interference vector, a first interference vector having a maximum aggregated weighted interference.

In some example embodiments, the apparatus further comprises means for receiving, from the second device, information indicative of the at least one sub-band for the first subnetwork after transmitting the weighted inter-subnetwork interference to the second device.

In some example embodiments, an apparatus capable of performing the method 400 (for example, implemented at the second device 120) may include means for performing the respective steps of the method 400. The means may be implemented in any suitable form. For example, the means may be implemented in a circuitry or software module.

In some example embodiments, the apparatus comprises means for transmitting, to at least one first device in at least one subnetwork of a radio access network, a configuration for determining a weighted inter-subnetwork interference among the at least one subnetwork, wherein the configuration is indicative of at least one of a first weighting or a second weighting for the weighted inter-subnetwork interference; and means for receiving from the at least one first device, the weighted inter-subnetwork interference for selecting at least one sub-band for the at least one subnetwork.

In some example embodiments, the means for transmitting the configuration for determining the weighted inter-subnetwork interference comprises means for transmitting the configuration via at least one of a dedicated signaling, or a common signaling.

In some example embodiments, the configuration for determining the weighted inter-subnetwork interference comprises at least one of a measurement configuration on reference signal of the at least one subnetwork, first configuration information associated with the first weighting, or second configuration information associated with the second weighting.

In some example embodiments, the second configuration information associated with the second weighting is indicative of a mapping between a plurality of second weighting factors and different service quality requirements.

In some example embodiments, the apparatus further comprises means for selecting the at least one sub-band for the at least one subnetwork based at least on the weighted inter-subnetwork interference; and means for transmitting to the at least one first device in the at least one subnetwork, the at least one sub-band.

In some example embodiments, an apparatus capable of performing the method 500 (for example, implemented at the third device 130) may include means for performing the respective steps of the method 500. The means may be implemented in any suitable form. For example, the means may be implemented in a circuitry or software module.

In some example embodiments, the apparatus comprises means for receiving, from a first device in a first subnetwork of a radio access network, a configuration for determining a first interference vector, wherein the first interference vector is associated with a weighted inter-subnetwork interference between the first subnetwork and at least one second subnetwork of the radio access network, and the configuration is indicative of at least a first weighting for the weighted inter-subnetwork interference; and means for transmitting, to the first device, a first interference vector determined based on the configuration.

In some example embodiments, the configuration for determining the first interference vector comprises at least one of a first measurement configuration on reference signal of the first subnetwork, a second measurement configuration on reference signal of the at least one second subnetwork, or first configuration information associated with the first weighting.

In some example embodiments, the apparatus further comprises means for performing an interference measurement on the reference signal of the first network and the at least one second subnetwork based on the first measurement configuration and the second measurement configuration on the RS port(s).

In some example embodiments, the apparatus further comprises means for determining the first interference vector based on measurement result of the interference measurement and a first weighting factor for the first weighting determined based on the first configuration information associated with the first weighting.

In some example embodiments, the first weighting factor is a reciprocal of measured received power of the reference signal of the first subnetwork.

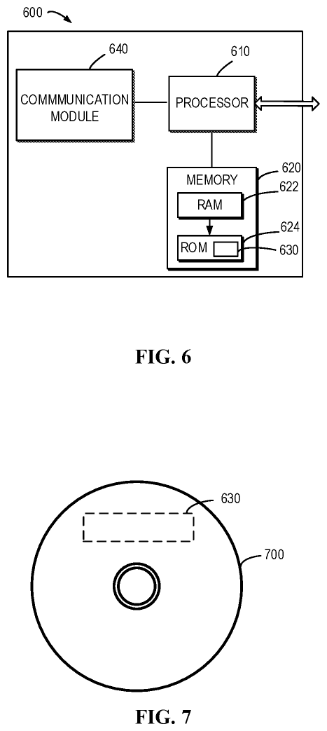

FIG. 6 is a simplified block diagram of a device 600 that is suitable for implementing example embodiments of the present disclosure. The device 600 may be provided to implement a communication device, for example, the AP 110, the BS 120 or the UE 130 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-28. (canceled)

29. A first device in a first subnetwork of a radio access network comprising:
a processor; and
a memory storing instructions that, when executed by the processor, cause the first device at least to:
receive, from a second device in the radio access network, a configuration for determining a weighted inter-subnetwork interference between the first subnetwork and a second subnetwork of the radio access network, wherein the configuration is indicative of a first weighting and a second weighting for the weighted inter-subnetwork interference, wherein the configuration for determining the weighted inter-subnetwork interference comprises the following:
a first measurement configuration on reference signal of the first subnetwork,
a second measurement configuration on reference signal of the second subnetwork,
first configuration information associated with the first weighting, and
second configuration information associated with the second weighting;
transmit, to a third device in the first subnetwork, the first and the second measurement configuration and the first configuration information;
receive, from the third device, a first interference vector determined based on the first and the second measurement configuration and the first configuration information;
obtain a second interference vector based on the first interference vector received from the third device;
determine a second weighting factor corresponding to a service quality requirement of the first subnetwork based on the second configuration information associated with the second weighting;
determine the weighted inter-subnetwork interference based on the second interference vector and the second weighting factor; and
transmit the weighted inter-subnetwork interference to the second device for selecting a sub-band for the first subnetwork.

30. The first device of claim 29, wherein the first device is caused to receive the configuration for determining the weighted inter-subnetwork interference via a common signaling.

31. The first device of claim 29, wherein the first device is caused to receive the configuration for determining the weighted inter-subnetwork interference via a dedicated signaling.

32. The first device of claim 31, wherein the second configuration information associated with the second weighting is indicative of a mapping between a plurality of second weighting factors and different service quality requirements, and wherein the first device is caused to:
determine the second weighting factor based on the service quality requirement of the first subnetwork and the mapping.

33. The first device of claim 32, wherein the first device is caused to obtain the second interference vector by calculating an average of the weighted interference vectors received from a plurality of user equipment in the subnetwork,
calculating a sum of the first interference vector, or
selecting an interference vector having a maximum aggregated weighted interference.

34. The first device of claim 33, wherein the first device is caused to:
receive, from the second device, information indicative of the sub-band for the first subnetwork after transmitting the weighted inter-subnetwork interference to the second device.

35. The first device of claim 34, wherein the first device comprises an access point, the second device comprises a base station and the third device comprises a terminal device.

36. A system comprising:
a first device in a first subnetwork of a radio access network;
a processor; and
a memory storing instructions that, when executed by the processor, cause the first device at least to:
receive, from a second device in the radio access network, a configuration for determining a weighted inter-subnetwork interference between the first subnetwork and a second subnetwork of the radio access network, wherein the configuration is indicative of a first weighting and a second weighting for the weighted inter-subnetwork interference, wherein the configuration for determining the weighted inter-subnetwork interference comprises the following:
a first measurement configuration on reference signal of the first subnetwork,
a second measurement configuration on reference signal of the second subnetwork,
first configuration information associated with the first weighting, and
second configuration information associated with the second weighting;
transmit, to a third device in the first subnetwork, the first and the second measurement configuration and the first configuration information;
receive, from the third device, a first interference vector determined based on the first and the second measurement configuration and the first configuration information;
obtain a second interference vector based on the first interference vector received from the third device;
determine a second weighting factor corresponding to a service quality requirement of the first subnetwork based on the second configuration information associated with the second weighting;
determine the weighted inter-subnetwork interference based on the second interference vector and the second weighting factor; and
transmit the weighted inter-subnetwork interference to the second device for selecting a sub-band for the first subnetwork.

37. The system of claim 36, wherein the first device is caused to receive the configuration for determining the weighted inter-subnetwork interference via a common signaling.

38. The system of claim 36, wherein the first device is caused to receive the configuration for determining the weighted inter-subnetwork interference via a dedicated signaling.

39. The system of claim 38, wherein the second configuration information associated with the second weighting is indicative of a mapping between a plurality of second weighting factors and different service quality requirements, and wherein the first device is caused to:
determine the second weighting factor based on the service quality requirement of the first subnetwork and the mapping.

40. The system of claim 39, wherein the first device is caused to obtain the second interference vector by calculating a sum of the weighted interference vectors received from a plurality of user equipment in the subnetwork.

41. The system of claim 40, wherein the first device is caused to:
receive, from the second device, information indicative of the sub-band for the first subnetwork after transmitting the weighted inter-subnetwork interference to the second device.

42. The system of claim 41, wherein the first device comprises an access point, the second device comprises a base station and the third device comprises a terminal device.

43. A method comprising:
receiving, by a first device from a second device in a radio access network, a configuration for determining a weighted inter-subnetwork interference between the first subnetwork and a second subnetwork of the radio access network, wherein the configuration is indicative of a first weighting and a second weighting for the weighted inter-subnetwork interference, wherein the configuration for determining the weighted inter-subnetwork interference comprises the following:
a first measurement configuration on reference signal of the first subnetwork,
a second measurement configuration on reference signal of the second subnetwork,
first configuration information associated with the first weighting, and
second configuration information associated with the second weighting;
transmitting, by the first device to a third device in the first subnetwork, the first and the second measurement configuration and the first configuration information;
receiving, by the first device from the third device, a first interference vector determined based on the first and the second measurement configuration and the first configuration information;
obtaining, by the first device, a second interference vector based on the first interference vector received from the third device;
determining, by the first device, a second weighting factor corresponding to a service quality requirement of the first subnetwork based on the second configuration information associated with the second weighting;
determining, by the first device, the weighted inter-subnetwork interference based on the second interference vector and the second weighting factor; and
transmitting, by the first device, the weighted inter-subnetwork interference to the second device for selecting a sub-band for the first subnetwork.

44. The method of claim 43, further comprising:
receiving the configuration for determining the weighted inter-subnetwork interference via a common signaling.

45. The method of claim 44, wherein the second configuration information associated with the second weighting is indicative of a mapping between a plurality of second weighting factors and different service quality requirements, and wherein the method further comprises:
determining the second weighting factor based on the service quality requirement of the first subnetwork and the mapping.

46. The method of claim 45, further comprising:
obtaining the second interference vector by selecting an interference vector, from a plurality of weighted interference vectors received from a plurality of user equipment in the subnetwork, that has a maximum aggregated weighted interference.

47. The method of claim 46, further comprising:
receiving, from the second device, information indicative of the sub-band for the first subnetwork after transmitting the weighted inter-subnetwork interference to the second device.

48. The method of claim 47, wherein the first device comprises an access point, the second device comprises a base station and the third device comprises a terminal device.
